(19) United States
(12) Patent Application Publication
(10) Pub. No.: US 2025/0013908 A1
(43) Pub. Date: Jan. 9, 2025

(54) METHOD AND SYSTEM FOR COMPUTING RECONCILED AND CONSISTENT EXPLANATIONS OVER TIME

(71) Applicant: JPMorgan Chase Bank, N.A., New York, NY (US)

(72) Inventors: Mattia Jacopo VILLANI, London (GB); Joshua LOCKHART, London (GB); Freddy LECUE, Mamaroneck, NY (US); Daniele MAGAZZENI, London (GB)

(73) Assignee: JPMorgan Chase Bank, N.A., New York, NY (US)

(21) Appl. No.: 18/217,876

(22) Filed: Jul. 3, 2023

(51) Int. Cl. G06N 20/00

(52) U.S. Cl. CPC G06N 20/00

(57) ABSTRACT

A method for providing explanations of predictive outputs is disclosed. The method includes receiving, via an application programming interface, an input; temporally segmenting the input to generate a finite set of time windows; training machine learning models for each of the time windows; generating, by using each of the trained machine learning models, predictions for a target time based on the input; generating a set of common background data for each of the time windows based on the input; determining respective mode explanations for each of the time windows based on the corresponding set of common background data, the corresponding trained machine learning models, and the corresponding predictions; and determining reconciled explanations for a target prediction that corresponds to the target time based on the input and the respective mode explanations.

### BACKGROUND

### 1. Field of the Disclosure

This technology generally relates to methods and systems for identifying consistent explanations, and more particularly to methods and systems for providing reconciled and consistent explanations of predictive machine learning outputs over time by computing estimations at different time windows.

### 2. Background Information

Many business entities facilitate various business functions by utilizing machine learning and artificial intelligence to estimate outputs and make predictions. Often, the machine learning and artificial intelligence processes rely on various collections of data points to estimate the outputs and make the predictions. Historically, implementations of conventional techniques for computing explanations of the estimated outputs and predictions have resulted in varying degrees of success with respect to determining reconciled and consistent explanations over time.

One drawback of using the conventional techniques for computing the explanations is that in many instances, data points that evolve over time on a temporal basis are highly dependent on previous signals and historical data. As a result, explanations of the estimated outputs and predictions are highly uncertain and continuously changing because of strong relation to corresponding results. Additionally, because of the high level of uncertainty and the changes, such explanations are qualified as non-consistent from a temporal perspective.

Therefore, there is a need to address the challenges of computing consistent explanation by computing different estimations that consider different time windows to reconcile the outputs and predictions with corresponding explanations over time.

### SUMMARY

The present disclosure, through one or more of its various aspects, embodiments, and/or specific features or sub-components, provides, inter alia, various systems, servers, devices, methods, media, programs, and platforms for providing reconciled and consistent explanations of predictive machine learning outputs over time by computing estimations at different time windows.

According to an aspect of the present disclosure, a method for providing explanations of predictive outputs is disclosed. The method is implemented by at least one processor. The method may include receiving, via an application programming interface, at least one input; temporally segmenting the at least one input to generate a finite set of at least one time window; training at least one model for each of the at least one time window; generating, by using each of the at least one trained model, at least one prediction for a target time based on the at least one input; generating a set of common background data for each of the at least one time window based on the at least one input; determining at least one respective mode explanation for each of the at least one time window based on the corresponding set of common background data, the corresponding at least one trained model, and the corresponding at least one prediction; and determining at least one reconciled explanation for a target prediction that corresponds to the target time based on the at least one input and the at least one respective mode explanation.

In accordance with an exemplary embodiment, the at least one input may include at least one from among raw data, a parameter, a weighting function that prioritizes a plurality of temporal time windows for consistency evaluation, a timestamp for the target time, a data sampling strategy, and a consistency factor.

In accordance with an exemplary embodiment, the raw data may include a series of data that represents an evolution of information over time, and the parameter may include a required number of the at least one time window.

In accordance with an exemplary embodiment, each of the at least one respective mode explanation may include at least one respective feature attribution for each of a plurality of segmented time windows with respect to a specific corresponding background data distribution.

In accordance with an exemplary embodiment, the at least one reconciled explanation may correspond to a consistent explanation for each of the at least one prediction over time.

In accordance with an exemplary embodiment, to determine the at least one reconciled explanation, the method may further include determining a consistency value for a plurality of features in each of the at least one respective mode explanation; and removing at least one feature from the plurality of features based on the consistency value and a consistency factor.

In accordance with an exemplary embodiment, the method may further include weighting, by using a weighting function, at least one remaining feature from the plurality of features based on a result of the removing; and determining at least one respective reconciled feature score for each of the at least one remaining feature.

In accordance with an exemplary embodiment, the consistency value may relate to a feature value distance of a plurality of proximate features that is determined based on a graphical projection of the at least one respective mode explanation.

In accordance with an exemplary embodiment, the at least one model may include at least one from among a large language model, a deep learning model, a neural network model, a natural language processing model, a machine learning model, a mathematical model, a process model, and a data model.

According to an aspect of the present disclosure, a computing device configured to implement an execution of a method for providing explanations of predictive outputs is disclosed. The computing device including a processor; a memory; and a communication interface coupled to each of the processor and the memory, wherein the processor may be configured to receive, via an application programming interface, at least one input; temporally segment the at least one input to generate a finite set of at least one time window; train at least one model for each of the at least one time window; generate, by using each of the at least one trained model, at least one prediction for a target time based on the at least one input; generate a set of common background data for each of the at least one time window based on the at least one input; determine at least one respective mode explanation for each of the at least one time window based on the corresponding set of common background data, the corresponding at least one trained model, and the corresponding at least one prediction; and determine at least one reconciled explanation for a target prediction that corresponds to the target time based on the at least one input and the at least one respective mode explanation.

In accordance with an exemplary embodiment, the at least one input may include at least one from among raw data, a parameter, a weighting function that prioritizes a plurality of temporal time windows for consistency evaluation, a timestamp for the target time, a data sampling strategy, and a consistency factor.

In accordance with an exemplary embodiment, the raw data may include a series of data that represents an evolution of information over time, and the parameter may include a required number of the at least one time window.

In accordance with an exemplary embodiment, each of the at least one respective mode explanation may include at least one respective feature attribution for each of a plurality of segmented time windows with respect to a specific corresponding background data distribution.

In accordance with an exemplary embodiment, the at least one reconciled explanation may correspond to a consistent explanation for each of the at least one prediction over time.

In accordance with an exemplary embodiment, to determine the at least one reconciled explanation, the processor may be further configured to determine a consistency value for a plurality of features in each of the at least one respective mode explanation; and remove at least one feature from the plurality of features based on the consistency value and a consistency factor.

In accordance with an exemplary embodiment, the processor may be further configured to weight, by using a weighting function, at least one remaining feature from the plurality of features based on a result of the removing; and determine at least one respective reconciled feature score for each of the at least one remaining feature.

In accordance with an exemplary embodiment, the consistency value may relate to a feature value distance of a plurality of proximate features that is determined based on a graphical projection of the at least one respective mode explanation.

In accordance with an exemplary embodiment, the at least one model may include at least one from among a large language model, a deep learning model, a neural network model, a natural language processing model, a machine learning model, a mathematical model, a process model, and a data model.

According to an aspect of the present disclosure, a non-transitory computer readable storage medium storing instructions for providing explanations of predictive outputs is disclosed. The storage medium including executable code which, when executed by a processor, may cause the processor to receive, via an application programming interface, at least one input; temporally segment the at least one input to generate a finite set of at least one time window; train at least one model for each of the at least one time window; generate, by using each of the at least one trained model, at least one prediction for a target time based on the at least one input; generate a set of common background data for each of the at least one time window based on the at least one input; determine at least one respective mode explanation for each of the at least one time window based on the corresponding set of common background data, the corresponding at least one trained model, and the corresponding at least one prediction; and determine at least one reconciled explanation for a target prediction that corresponds to the target time based on the at least one input and the at least one respective mode explanation.

In accordance with an exemplary embodiment, the at least one input may include at least one from among raw data, a parameter, a weighting function that prioritizes a plurality of temporal time windows for consistency evaluation, a timestamp for the target time, a data sampling strategy, and a consistency factor.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing reconciled and consistent explanations of predictive machine learning outputs over time by computing estimations at different time windows.

FIG. 4 is a flowchart of an exemplary process for implementing a method for providing reconciled and consistent explanations of predictive machine learning outputs over time by computing estimations at different time windows.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

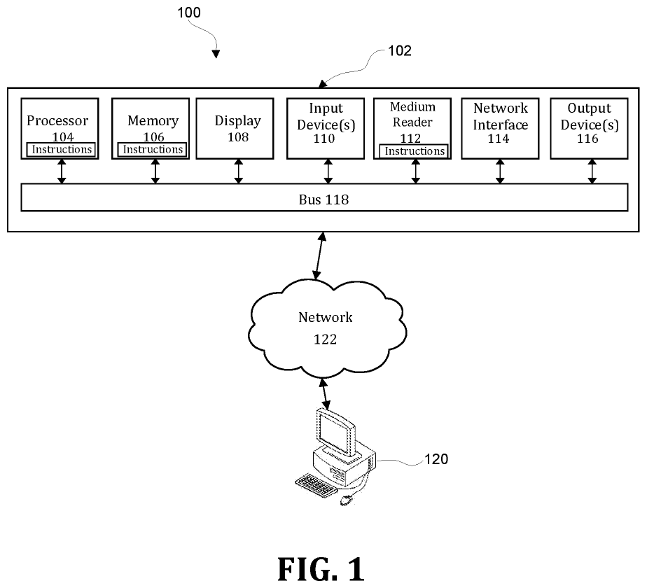

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a GPS device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing reconciled and consistent explanations of predictive machine learning outputs over time by computing estimations at different time windows.

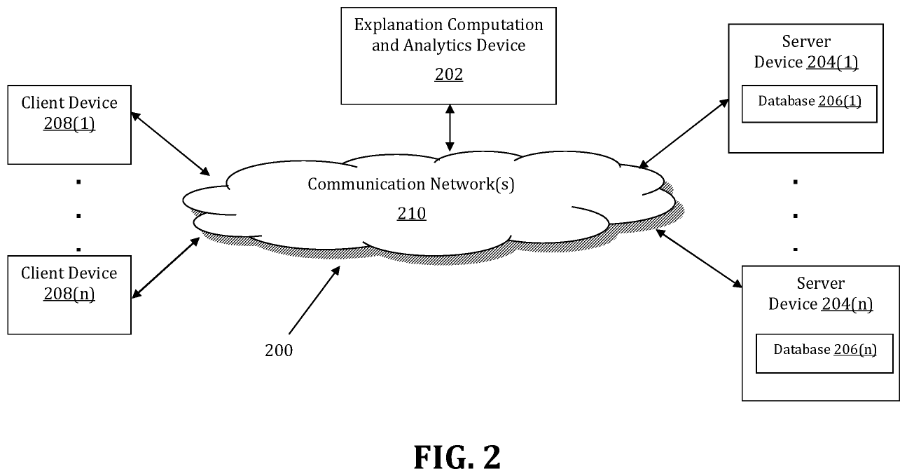

Referring to FIG. 2, a schematic of an exemplary network environment 200 for implementing a method for providing reconciled and consistent explanations of predictive machine learning outputs over time by computing estimations at different time windows is illustrated. In an exemplary embodiment, the method is executable on any networked computer platform, such as, for example, a personal computer (PC).

The method for providing reconciled and consistent explanations of predictive machine learning outputs over time by computing estimations at different time windows may be implemented by an Explanation Computation and Analytics (ECA) device 202. The ECA device 202 may be the same or similar to the computer system 102 as described with respect to FIG. 1. The ECA device 202 may store one or more applications that can include executable instructions that, when executed by the ECA device 202, cause the ECA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ECA device 202 itself, may be located in virtual server(s) running in a cloud-based computing environment rather than being tied to one or more specific physical network computing devices. Also, the application(s) may be running in one or more virtual machines (VMs) executing on the ECA device 202. Additionally, in one or more embodiments of this technology, virtual machine(s) running on the ECA device 202 may be managed or supervised by a hypervisor.

In the network environment 200 of FIG. 2, the ECA device 202 is coupled to a plurality of server devices 204(1)-204(n) that hosts a plurality of databases 206(1)-206(n), and also to a plurality of client devices 208(1)-208(n) via communication network(s) 210. A communication interface of the ECA device 202, such as the network interface 114 of the computer system 102 of FIG. 1, operatively couples and communicates between the ECA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ECA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and ECA devices that efficiently implement a method for providing reconciled and consistent explanations of predictive machine learning outputs over time by computing estimations at different time windows.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ECA device 202 may be a standalone device or integrated with one or more other devices or apparatuses, such as one or more of the server devices 204(1)-204(n), for example. In one particular example, the ECA device 202 may include or be hosted by one of the server devices 204(1)-204(n), and other arrangements are also possible. Moreover, one or more of the devices of the ECA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ECA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to inputs, raw data, parameters, weighting functions, timestamps, data sampling strategies, consistency factors, time windows, machine learning models, predictions, common background data, mode explanations, and reconciled explanations.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ECA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ECA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ECA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ECA device 202, the server devices 204(1)-204(n), or the client devices 208(1)-208(n), for example, may be configured to operate as virtual instances on the same physical machine. In other words, one or more of the ECA device 202, the server devices 204(1)-204(n), or the client devices 208(1)-208(n) may operate on the same physical device rather than as separate devices communicating through communication network(s) 210. Additionally, there may be more or fewer ECA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

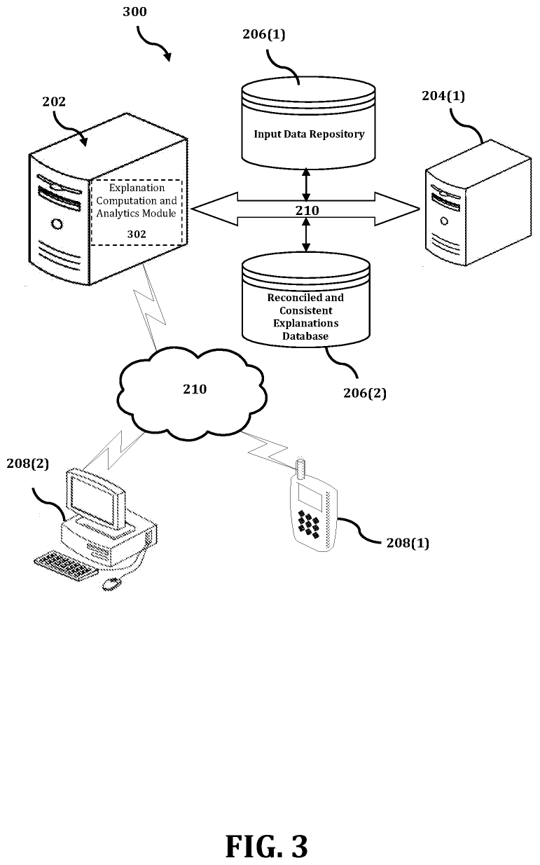

The ECA device 202 is described and shown in FIG. 3 as including an explanation computation and analytics module 302, although it may include other rules, policies, modules, databases, or applications, for example. As will be described below, the explanation computation and analytics module 302 is configured to implement a method for providing reconciled and consistent explanations of predictive machine learning outputs over time by computing estimations at different time windows.

An exemplary process 300 for implementing a mechanism for providing reconciled and consistent explanations of predictive machine learning outputs over time by computing estimations at different time windows by utilizing the network environment of FIG. 2 is shown as being executed in FIG. 3. Specifically, a first client device 208(1) and a second client device 208(2) are illustrated as being in communication with ECA device 202. In this regard, the first client device 208(1) and the second client device 208(2) may be “clients” of the ECA device 202 and are described herein as such. Nevertheless, it is to be known and understood that the first client device 208(1) and/or the second client device 208(2) need not necessarily be “clients” of the ECA device 202, or any entity described in association therewith herein. Any additional or alternative relationship may exist between either or both of the first client device 208(1) and the second client device 208(2) and the ECA device 202, or no relationship may exist.

Further, ECA device 202 is illustrated as being able to access an input data repository 206(1) and a reconciled and consistent explanations database 206(2). The explanation computation and analytics module 302 may be configured to access these databases for implementing a method for providing reconciled and consistent explanations of predictive machine learning outputs over time by computing estimations at different time windows.

The first client device 208(1) may be, for example, a smart phone. Of course, the first client device 208(1) may be any additional device described herein. The second client device 208(2) may be, for example, a PC. Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the ECA device 202 via broadband or cellular communication. Of course, these embodiments are merely exemplary and are not limiting or exhaustive.

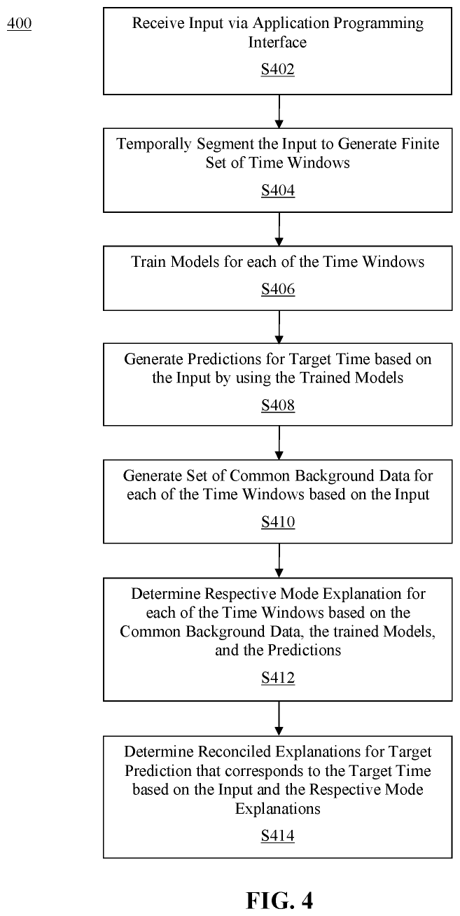

Upon being started, the explanation computation and analytics module 302 executes a process for providing reconciled and consistent explanations of predictive machine learning outputs over time by computing estimations at different time windows. An exemplary process for providing reconciled and consistent explanations of predictive machine learning outputs over time by computing estimations at different time windows is generally indicated at flowchart 400 in FIG. 4.

In the process 400 of FIG. 4, at step S402, inputs may be received via an application programming interface. In an exemplary embodiment, the inputs may include at least one from among raw data, a parameter, a weighting function that prioritizes a plurality of temporal time windows for consistency evaluation, a timestamp for the target time, a data sampling strategy, and a consistency factor. The data sampling strategy may include a ratio for sampling data such as, for example, that twenty-one percent of data will be selected from the input data.

The raw data may include a series of data that represents an evolution of information over time. For example, the raw data may include a collection of data points and corresponding feature values that evolve over time. The parameter may include a required number of the time windows. For example, the parameter may include a value K that indicates a number of time windows to be computed. Consistent with present disclosures, the number of windows to be computed may be usable in the determining of a weighting strategy. For example, stronger weight may be given to windows with the last two temporal elements included.

At step S404, the inputs may be temporally segmented to generate a finite set of time windows. In an exemplary embodiment, the raw data that evolves over time in the input may be segmented into a finite set of time windows. The raw data may be segmented based on predetermined parameters in the input. For example, the raw data may be segmented into four time windows when the predetermined parameters indicate that four time windows are required for computation. The raw data may be segmented into various time windows with different time characteristics. For example, the time characteristics may indicate that every other point in time is selected or that a group of consecutive points in time is selected.

At step S406, models may be trained for each of the time windows. In an exemplary embodiment, the models may be trained for each of the targeted time windows. The targeted time windows may correspond to the temporally segmented time windows. The model may be trained by using data in the input such as, for example, raw data for the targeted time windows.

In another exemplary embodiment, the models may include at least one from among a large language model, a deep learning model, a neural network model, a natural language processing model, a machine learning model, a mathematical model, a process model, and a data model. The models may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori algorithm analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the machine learning process may include a neural network that relates to at least one from among an artificial neural network and a simulated neural network. The neural network may correspond to a technique in artificial intelligence that teaches computers to process data by using interconnected processing nodes and/or artificial neurons. The neural network may relate to a type of machine learning such as, for example, deep learning that uses interconnected nodes and/or artificial neurons in a layered structure to transform inputs for predictive analytics.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

In another exemplary embodiment, the large language model may relate to a trained deep-learning model that understands and generates text in a human-like fashion. The large language model may recognize, summarize, translate, predict, and generate various types of text as well as content based on knowledge gained from massive data sets. In another exemplary embodiment, the large language model may correspond to a language model that consists of a neural network with many parameters such as, for example, weights. The language model may be trained on large quantities of unlabeled and labeled text by using self-supervised learning or semi-supervised learning. The trained language model may be usable to capture syntax and semantics of human language.

At step S408, predictions for a target time may be generated based on the inputs. The predictions may be generated by using each of the trained models. In an exemplary embodiment, the aim may be to run predictions on input targeted time by using the corresponding targeted windows. That is, the predictions may be determined for a targeted time that is predetermined and indicated by the timestamp that is included in the input. The predictions may relate to any combination of estimations and/or predictions that are determined by each of the trained models for the corresponding time windows. For example, predictions may be made for time “t+3” in time windows one through four by using the trained models that correspond to each of the time windows.

At step S410, sets of common background data may be generated for each of the time windows based on the inputs. In an exemplary embodiment, the sets of common background data may be computed from among the input data for each of the time windows. The sets of common background data may be computed based on a data sampling strategy in the input such as, for example, a ratio for sampling data. For example, the sampling process may include a sampling step that samples X % of data from the targeted windows where X corresponds to the ratio for sampling the data.

At step S412, respective mode explanations may be determined for each of the time windows based on the corresponding sets of common background data, the corresponding trained models, and the corresponding predictions. In an exemplary embodiment, each of the respective mode explanations may include respective feature attributions for each of a plurality of segmented time windows with respect to a specific corresponding background data distribution. That is, the mode explanations may include feature attributions that have been computed for each segmented time window with respect to corresponding background data distribution.

In another exemplary embodiment, the model explanation techniques that are used to determine the mode explanations may correspond to any techniques for identifying feature attribution such as, for example, SHAPLEY additive explanations (SHAP) techniques, feature importance techniques, and counterfactual techniques. The SHAP techniques may be usable to explain the output of machine learning models. The SHAP techniques may be based on SHAP values, which are usable in game theory to assign attribution for a model's prediction to each feature and/or each value.

In another exemplary embodiment, the SHAP values may be usable for event detection. Formally, it may be understood that yt=f (yt-1, . . . , yt-W) and that yt-1=f (yt-2, . . . , yt-W). Therefore, when the SHAP values for yt-2 are computed, for example, the importance that a feature had in a first prediction and in a second prediction may be obtained. This process may be repeated for all time windows in which yt-2 appears. After summing over all of the collected terms, event detection values for yt-2 may be obtained. In short, this methodology may allow for a determination of how important time step yt-2 was for any prediction. It is expected that this may spike when yt-2 is an important event that affects multiple predictions in time to a strong extent.

In another exemplary embodiment, the SHAP values may be extended for time consistency in the context of time series. The time consistency of SHAP values may be presented as:

$${\sum }_{w = 0}^{t - 1} β ( w , i ) + ϕ ( t , i ) = ϕ ( 0 , i ) .$$

Where β may represent an imputation schedule of payments made to player i across time steps t in a game theory analysis of a theoretical game. Note that here ϕ(0,i) may be taken to be the total value that players i contributes to the game. A motivating example may be that of an oligopoly, in which collaborating players agree to a strategy but need an incentive scheme that will make deal renegotiation or dropping out undesirable. In that case, an initial sum may be agreed upon based on the value each contributor will bring to the game, and dividends are paid according to marginal contributions to the subgames.

Computing these values in the context of a prediction problem may be accomplished through three steps. In the first step, total SHAP of features i may be computed by masking intermittently their visible history. This may be referred to as a feature SHAP. In the second step, for w∈[W], subgame SHAP may be computed for time steps t-w by fixing the interval starting at t-W and completing at t-w to their observed value, and masking the remaining intervals. This may be done according to the different coalitions of players S∈P([N])/{i}. In the third step, the imputation schedule as defined in the time consistency of SHAP values equation may be computed.

The computation process overall may be parallelizable as linear models are fitted for each sub-window. Notice that in the presence of large lookback windows, approximating SHAP values through kernel SHAP may become infeasible. This may be due to the combinatorial term in the kernel, which explodes, leading to numerical underflow or near zero regression weights. However, time consistent SHAP may scale with the size of the window.

At step S414, reconciled explanations may be determined for target predictions that correspond to the target time based on the inputs and the respective mode explanations. In an exemplary embodiment, the reconciled explanations may correspond to consistent explanations for each of the predictions over time. The reconciled explanations for a set of predictions may be computed as a reconciliation of explanations over time. Consistent with present disclosures, the set of predictions may correspond to various outputs from different models.

In another exemplary embodiment, to determine the reconciled explanations, consistency values may be determined for a plurality of features in each of the respective mode explanations. The consistency values may relate to a feature value distance of a plurality of proximate features that is determined based on a graphical projection of the respective mode explanations. The proximity of the features may be determined based on a comparison between the feature value distance and the consistency factor. For example, consistency may be satisfied when the distance between two feature values of explanations projected for the feature is less than the consistency factor. Then, features may be removed from the plurality of features based on the consistency value and the consistency factor. For example, features which are not consistent with other features may be removed.

In another exemplary embodiment, remaining features from the plurality of features may be weighted by using a weighting function. The remaining features may relate to features that have not been removed based on a result of the removing step. For example, weighting strategies may be applied to each of the remaining features. Then, respective reconciled feature scores may be determined for each of the remaining features. For example, new reconciliated feature scores may be computed for the remaining features. Consistent with present disclosures, the output of the aforementioned process may include a reconciliated explanation for the targeted prediction.

In another exemplary embodiment, to compute the reconciled explanations, explanations of a set of predictions for various models may be computed as a reconciliation of explanations over time consistent with present disclosures. The computation process may include the graphical projection of the mode explanations on a multidimensional graph. The mode explanations may be plotted on the multidimensional graph based on corresponding feature values. The multidimensional graph may include at least one from among a floating number value dimension, a name of the feature dimension, and a segmented time window dimension. All distances between values of explanations projected for the features may be determined to be consistent when less than the consistency factor. Consistent with present disclosures, the representation of explanations in the reconciliated explanation space may be graphically projected on any multidimensional graph with any combination of dimensions.

Then, consistent with present disclosures for each of the features in the mode explanations, features which may not be consistent with other features may be removed. Here, the consistency may be satisfied when the distance between two values of the explanations projected for the feature is less than the consistency factor. Weight strategies may be applied to each of the remaining features. Similarly, new reconciliated feature scores may be computed for the remaining features. As such, the output may include reconciliated temporal explanations for the targeted predictions as well as justification of the reconciliation. The justification of the reconciliation may indicate that more weighted factors are applied for explanation computation of background data distribution for certain segmented time windows over other segmented time windows.

Accordingly, with this technology, an optimized process for providing reconciled and consistent explanations of predictive machine learning outputs over time by computing estimations at different time windows is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing explanations of predictive outputs, the method being implemented by at least one processor, the method comprising:
receiving, by the at least one processor via an application programming interface, at least one input;
temporally segmenting, by the at least one processor, the at least one input to generate a finite set of at least one time window;
training, by the at least one processor, at least one model for each of the at least one time window;
generating, by the at least one processor using each of the at least one trained model, at least one prediction for a target time based on the at least one input;
generating, by the at least one processor, a set of common background data for each of the at least one time window based on the at least one input;
determining, by the at least one processor, at least one respective mode explanation for each of the at least one time window based on the corresponding set of common background data, the corresponding at least one trained model, and the corresponding at least one prediction; and
determining, by the at least one processor, at least one reconciled explanation for a target prediction that corresponds to the target time based on the at least one input and the at least one respective mode explanation.

2. The method of claim 1, wherein the at least one input includes at least one from among raw data, a parameter, a weighting function that prioritizes a plurality of temporal time windows for consistency evaluation, a timestamp for the target time, a data sampling strategy, and a consistency factor.

3. The method of claim 2, wherein the raw data includes a series of data that represents an evolution of information over time, and wherein the parameter includes a required number of the at least one time window.

4. The method of claim 1, wherein each of the at least one respective mode explanation includes at least one respective feature attribution for each of a plurality of segmented time windows with respect to a specific corresponding background data distribution.

5. The method of claim 1, wherein the at least one reconciled explanation corresponds to a consistent explanation for each of the at least one prediction over time.

6. The method of claim 1, wherein the determining of the at least one reconciled explanation further comprises:
determining, by the at least one processor, a consistency value for a plurality of features in each of the at least one respective mode explanation; and
removing, by the at least one processor, at least one feature from the plurality of features based on the consistency value and a consistency factor.

7. The method of claim 6, further comprising:
weighting, by the at least one processor using a weighting function, at least one remaining feature from the plurality of features based on a result of the removing; and
determining, by the at least one processor, at least one respective reconciled feature score for each of the at least one remaining feature.

8. The method of claim 6, wherein the consistency value relates to a feature value distance of a plurality of proximate features that is determined based on a graphical projection of the at least one respective mode explanation.

9. The method of claim 1, wherein the at least one model includes at least one from among a large language model, a deep learning model, a neural network model, a natural language processing model, a machine learning model, a mathematical model, a process model, and a data model.

10. A computing device configured to implement an execution of a method for providing explanations of predictive outputs, the computing device comprising:
a processor;
a memory; and
a communication interface coupled to each of the processor and the memory,
wherein the processor is configured to:
receive, via an application programming interface, at least one input;
temporally segment the at least one input to generate a finite set of at least one time window;
train at least one model for each of the at least one time window;
generate, by using each of the at least one trained model, at least one prediction for a target time based on the at least one input;
generate a set of common background data for each of the at least one time window based on the at least one input;
determine at least one respective mode explanation for each of the at least one time window based on the corresponding set of common background data, the corresponding at least one trained model, and the corresponding at least one prediction; and
determine at least one reconciled explanation for a target prediction that corresponds to the target time based on the at least one input and the at least one respective mode explanation.

11. The computing device of claim 10, wherein the at least one input includes at least one from among raw data, a parameter, a weighting function that prioritizes a plurality of temporal time windows for consistency evaluation, a timestamp for the target time, a data sampling strategy, and a consistency factor.

12. The computing device of claim 11, wherein the raw data includes a series of data that represents an evolution of information over time, and wherein the parameter includes a required number of the at least one time window.

13. The computing device of claim 10, wherein each of the at least one respective mode explanation includes at least one respective feature attribution for each of a plurality of segmented time windows with respect to a specific corresponding background data distribution.

14. The computing device of claim 10, wherein the at least one reconciled explanation corresponds to a consistent explanation for each of the at least one prediction over time.

15. The computing device of claim 10, wherein, to determine the at least one reconciled explanation, the processor is further configured to:
determine a consistency value for a plurality of features in each of the at least one respective mode explanation; and
remove at least one feature from the plurality of features based on the consistency value and a consistency factor.

16. The computing device of claim 15, wherein the processor is further configured to:
weight, by using a weighting function, at least one remaining feature from the plurality of features based on a result of the removing; and
determine at least one respective reconciled feature score for each of the at least one remaining feature.

17. The computing device of claim 15, wherein the consistency value relates to a feature value distance of a plurality of proximate features that is determined based on a graphical projection of the at least one respective mode explanation.

18. The computing device of claim 10, wherein the at least one model includes at least one from among a large language model, a deep learning model, a neural network model, a natural language processing model, a machine learning model, a mathematical model, a process model, and a data model.

19. A non-transitory computer readable storage medium storing instructions for providing explanations of predictive outputs, the storage medium comprising executable code which, when executed by a processor, causes the processor to:
receive, via an application programming interface, at least one input;
temporally segment the at least one input to generate a finite set of at least one time window;
train at least one model for each of the at least one time window;
generate, by using each of the at least one trained model, at least one prediction for a target time based on the at least one input;
generate a set of common background data for each of the at least one time window based on the at least one input;
determine at least one respective mode explanation for each of the at least one time window based on the corresponding set of common background data, the corresponding at least one trained model, and the corresponding at least one prediction; and
determine at least one reconciled explanation for a target prediction that corresponds to the target time based on the at least one input and the at least one respective mode explanation.

20. The storage medium of claim 19, wherein the at least one input includes at least one from among raw data, a parameter, a weighting function that prioritizes a plurality of temporal time windows for consistency evaluation, a timestamp for the target time, a data sampling strategy, and a consistency factor.
